(19) United States
(12) Patent Application Publication
(10) Pub. No.: US 2016/0112356 A1
(43) Pub. Date: Apr. 21, 2016

(54) Network Device and Method for Processing Email Request

(71) Applicant: Huawei Technologies Co., Ltd., Shenzhen (CN)

(72) Inventors: Nenghong Zheng, Hangzhou (CN); Xianzhi Guo, Hangzhou (CN)

(21) Appl. No.: 14/978,975

(22) Filed: Dec. 22, 2015

Related U.S. Application Data
(63) Continuation of application No. PCT/CN2013/077995, filed on Jun. 26, 2013.

(51) Int. Cl. H04L 12/58

(52) U.S. Cl. CPC H04L 51/066

(57) ABSTRACT

A network device and a method for processing an email request are disclosed. The network device includes a communications interface and a processor. The communications interface is configured to communicate with a client device and an email server. The processor is configured to receive a first request from the client device for fetching a portion of an email message. The processor generates a second request for fetching the email message in its entirety according to the first request. After receiving the email message that is in an encoded form and that is returned according to the second request by the email server, the processor decodes the email message to obtain the portion in a decoded form. Then the processor forwards the portion of the email message to the client device.

### CROSS-REFERENCE TO RELATED APPLICATIONS

This application is a continuation of International Application No. PCT/CN2013/077995, filed on Jun. 26, 2013, which is hereby incorporated by reference in its entirety.

### TECHNICAL FIELD

The present disclosure relates to the field of communications technologies, and in particular, to a network device and a method for processing an email request.

### BACKGROUND

An electronic mail (E-mail) is a communication manner of providing information exchange by electronic means. By using an email system on a network, a user can contact a network user anywhere in the world in a very fast manner. An email message may be in various forms such as text, image, and sound. Internet Message Access Protocol 4 (IMAP4) is a protocol that specifies how a personal computer remotely accesses an email server on the Internet to send and receive a mail. IMAP4 supports that a client, online or offline, can access and read an email message on a server. A user may directly perform an operation on the email message on the server by using a client device. Here, the operation includes reading a mail message online or checking information online such as an email subject, a size, or a sender address. The user may further maintain (including operations such as moving, creating, deleting, renaming, sharing or capturing text) a mailing directory of the user on the server. IMAP4 supports that the user can determine, by browsing an email header, whether to receive or delete a specific portion of a mail, and creating or changing a folder or a mailbox on the email server. In addition, besides supporting an offline operation mode of Post Office Protocol 3 (POP3), IMAP4 further supports an online operation and a disconnected operation. Therefore, IMAP4 provides the user with a function of selectively receiving a mail message from the email server, an information processing function based on the server, and a mailbox sharing function. Currently, IMAP4 has been widely applied as an important mail protocol.

At present, many security gateway devices support IMAP4. The security gateway devices generally implement, based on IMAP4, proxy of an email server. A security gateway receives a mail operation request sent by a client, and forwards, to the client according to the mail operation request, an email message acquired from the email server. In addition, the security gateway can implement, in the proxy process, security processing such as antivirus processing or mail filtering on the email message, so as to protect security of the client.

However, in the prior art, in a situation in which a user receives only a portion of an email message (for example, an attachment of an email), a security gateway cannot obtain content of the portion, in decoded form, of the email message. Therefore, the security gateway can forward, to the user, only the portion of the email message that does not undergo security processing and that is returned by an email server.

### SUMMARY

According to a network device and a method for processing an email request provided by embodiments of the present disclosure, in a situation in which a client device acquires only other portions, except an email header, of an email message, content, in decoded form, of the portion of the email message can be obtained on the network device.

According to a first aspect, an embodiment of the present disclosure provides a network device. The network device includes a communications interface and a processor. The communications interface communicates with a client device and an email server. The processor is configured to receive a first request from the client device for fetching a portion of an email message, where the portion of the email message does not include a header of the email message. Then, the processor is configured to generate a second request for fetching the email message in its entirety according to the first request, and send the second request to the email server. After receiving the email message in an encoded form from the email server, the processor is configured to decode the email message to obtain the portion in a decoded form, and forward the portion of the email message to the client device.

According to a second aspect, an embodiment of the present disclosure provides a method for processing an email request. The method is performed by a network device for processing requests from a client device to retrieve emails from an email server. In the method, the network device receives a first request from the client device for fetching a portion of an email message, where the portion of the email message does not comprise a header of the email message. After generating a second request for fetching the email message in its entirety according to the first request, the network device sends the second request to the email server. When the processor receives the email message in an encoded form from the email server, the processor decodes the email message to obtain the portion in a decoded form and forwards the portion of the email message to the client device.

According to a third aspect, an embodiment of the present disclosure provides a non-transitory machine-readable medium configured to store a computer instruction that can execute the foregoing method.

According to the network device provided by the embodiment of the present disclosure, after a first request from a client device for fetching other portions, except an email header, of an email message is received, a second request for fetching the email message in its entirety is generated according to the first request. Then, transfer encoding information of the portion, to be acquired by the client device, of the email message can be acquired from the entire email message returned by an email server. Further, the network device uses the transfer encoding information of the email message to decode the email message, such that in an application scenario in which the client device acquires only the portion, except the email header, of the email message, the network device can also obtain content of the portion in decoded form. The network device provided by this embodiment of the present disclosure enhances protection of the client device.

### BRIEF DESCRIPTION OF DRAWINGS

To describe the technical solutions in the embodiments of the present disclosure more clearly, the following briefly introduces the accompanying drawings required for describing the embodiments.

FIG. 1 is a diagram of an application scenario of a method for processing an email request according to an embodiment of the present disclosure;

FIG. 2 is a schematic structural diagram of an email message according to an embodiment of the present disclosure;

FIG. 3 is a schematic diagram of a physical structure of a security gateway according to an embodiment of the present disclosure;

FIG. 4 is a flowchart of a method for processing an email request according to an embodiment of the present disclosure;

FIG. 5 is a flowchart of another method for processing an email request according to an embodiment of the present disclosure; and

FIG. 6 is a schematic signaling diagram of another method for processing an email request according to an embodiment of the present disclosure.

### DESCRIPTION OF EMBODIMENTS

To make a person skilled in the art understand the technical solutions in the present disclosure better, the following clearly describes the technical solutions in the embodiments of the present disclosure with reference to the accompanying drawings in the embodiments of the present disclosure. The described embodiments are merely a portion rather than all of the embodiments of the present disclosure.

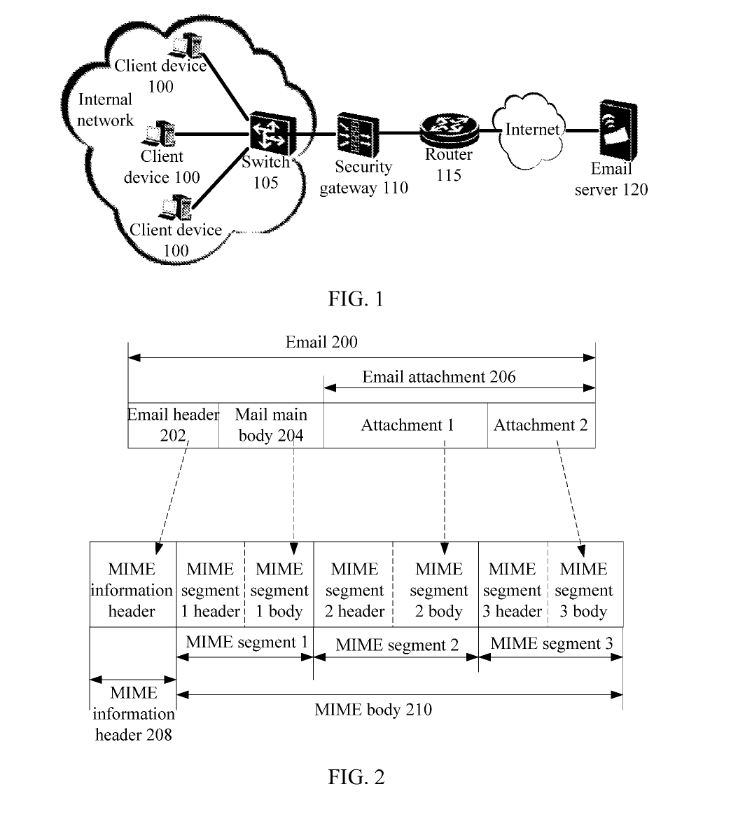

FIG. 1 is a diagram of an application scenario of a method for processing an email request according to an embodiment of the present disclosure. In the application scenario shown in FIG. 1, a client device 100, a switch 105, a security gateway 110, a router 115, and an email server 120 are included. The client device 100, the security gateway 110, and the email server 120 can support IMAP4. The security gateway 110 may be deployed at an egress of an intranet, an egress of the Internet, or a front end of the email server 120. The security gateway 110 may establish a connection between the client device 100 and the email server 120 in a transparent proxy or non-transparent proxy manner. The security gateway 110 can perform security processing, such as virus detection and mail filtering, on an email message sent by the email server 120 to the client device 100, so as to protect security of the client device 100 on the intranet. Transparent proxy refers to that the client device 100 does not know the existence of a proxy device (for example, the security gateway 110 in FIG. 1), and the client device 100 and the email server 120 can communicate with each other using a transparent channel established by the security gateway 110. Non-transparent proxy refers to that the client device 100 knows the existence of the security gateway 110, and the client device 100 can access the email server 120 only using the security gateway 110.

For example, in the application scenario shown in FIG. 1, the security gateway 110 is deployed at the egress of the intranet, and establishes the connection between the client device 100 and the email server 120 in the transparent proxy manner. The client device 100 accesses, based on IMAP4, the email server 120 on the Internet. An access request of the client device 100 arrives at the security gateway 110 using the switch 105. Serving as a proxy device of the email server 120, the security gateway 110 may determine, according to the access request of the client device 100, whether the security gateway 110 has cached an email message required by the client device 100. If the email message required by the client device 100 is cached, the security gateway 110 may directly send the email message to the client device 100. If no email message required by the client device 100 is cached, the security gateway 110 may send the access request of the client device 100 to the email server 120 using the router 115, and forward the email message to the client device 100 after performing security processing, such as virus detection and mail filtering, on the email message returned by the email server 120.

In this embodiment of the present disclosure, multiple client devices 100 may be included. The client device 100 may be a device that can implement network access, for example, a mobile phone or a computer. It should be noted that the security gateway 110 in this embodiment of the present disclosure is only an example of a network device. This embodiment of the present disclosure may also be applied to another network device that can implement, based on IMAP4, a mail proxy function, for example, a firewall. In addition, the network device may be separately deployed on a network as an independent device, or may be located in another device such as a firewall or a security gateway, which is not limited in this embodiment.

Most email messages are transmitted in a format specified by a Multipurpose Internet Mail Extensions (MIME) protocol. The MIME protocol is an extended email standard and can support email messages of various formats such as a non-ASCII (American Standard Code for Information Interchange) character and a binary format attachment. For clarity of description, in this embodiment of the present disclosure, the email message is divided into three portions: an email header, a mail main body, and an attachment. The email header includes information such as an email sent date, a sender address, a receiver address, and an email subject.

A person skilled in the art can learn that the MIME protocol is implemented by means of header additional fields of a standard email message. These header additional fields describe content and an organizational form of a new message type. In this embodiment of the present disclosure, an email message in an MIME format is divided into an MIME information header and an MIME body. The MIME information header is implemented by adding header additional fields of an email header of the email message. According to this manner, the MIME information header includes content of the email header. Field information recorded in the additional fields in the MIME information header acts on the entire email message. The MIME information header may include the following fields: MIME-Version: MIME version, which is used to indicate a version of an MIME protocol with which a packet complies, for example, Mime-Version: 1.0; Content-Type: content type, which is used to specify a type of a packet. Generally, Content-Type may include text, image, audio, video, applications, multipart, message, and the like, for example, Content-Type: multipart/mixed. Content-Type may further include a character set (char set) of a text encoding manner of a main body or the like, where the character set may include character types such as ASCII, GB2312, Times New Roman, and Arial; Content-Transfer-Encoding: content transfer encoding, which is used to specify an encoding manner executed for data and includes transfer encoding types such as 7 bit, 8 bit, base64, binary, quoted-printable, and custom, for example, Content-Transfer-Encoding: base64; Content-Disposition: content disposition, which is used to prompt a customer to decide whether an attachment is displayed inline or acts as an independent attachment, for example, Content-Disposition: attachment; and Content-Description: content description, which is a free text used to describe any information segment content.

The MIME body may include multiple MIME segments. Each MIME segment is implemented by adding header additional fields of a main body or an attachment of an email. According to this manner, the MIME segments separately include the main body or the attachment of the email. In this embodiment of the present disclosure, each MIME segment is divided into an MIME segment header and an MIME segment body. The MIME segment header may include any other field, except MIME-Version, in the MIME information header. Field information recorded in the MIME segment header can act on only the MIME segment. For example, if Content-Transfer-Encoding exists in the MIME information header, it is applied to an entire information body. However, if Content-Transfer-Encoding is displayed in an MIME segment header of an MIME segment, it can be applied to only the MIME segment. Because any non-7 bit data in an email message can pass through an Internet mail gateway only after being encoded in an encoding mode, a client device may decode a received email message using Content-Transfer-Encoding information. The MIME segment body includes a main body or attachment of an email that is encoded using Content-Transfer-Encoding in the MIME segment header. It can be understood that, if the MIME segment header does not include the Content-Transfer-Encoding information, the MIME segment body is a main body or attachment of an email that is encoded using Content-Transfer-Encoding information included in the MIME information header.

FIG. 2 is a schematic structural diagram of an email message according to an embodiment of the present disclosure. As shown in FIG. 2, an email message 200 includes an email header 202, a mail main body 204, and an email attachment 206. The email attachment 206 includes two attachments: an attachment 1 and an attachment 2. After the email message 200 is processed using a format specified in an MIME protocol, the email message 200 may be divided into two portions: an MIME information header 208 and an MIME body 210. The MIME information header 208 includes information in the email header 202, and may include information such as a sending date of the email message, a sender address, a receiver address, and an email subject. The MIME body 210 further includes three MIME segments: an MIME segment 1, an MIME segment 2, and an MIME segment 3. The MIME segment 1 includes content of the mail main body 204; the MIME segment 2 includes content of the attachment 1; and the MIME segment 3 includes content of the attachment 2. Each MIME segment is further divided into two portions: an MIME segment header and an MIME segment body. For example, the MIME segment 1 is divided into an MIME segment 1 header and an MIME segment 1 body; the MIME segment 2 is divided into an MIME segment 2 header and an MIME segment 2 body; and the MIME segment 3 is divided into an MIME segment 3 header and an MIME segment 3 body. The MIME segment 1 header may include field information such as Content-Type and Content-Transfer-Encoding, where a Content-Type field may further include a character set (char set) of the mail main body 204; and the MIME segment 1 body includes content of the mail main body 204 that is encoded in an encoding manner specified by a Content-Transfer-Encoding field in the MIME segment 1 header. The MIME segment 2 header may include field information such as Content-Type, Content-Transfer-Encoding, and Content-Disposition. In a Content-Disposition field, a file name of an attachment may further be specified, and the MIME segment 2 body includes content of the attachment 1 that is encoded in an encoding manner specified by a Content-Transfer-Encoding field in the MIME segment 2 header. A structure of the MIME segment 3 is similar to that of the MIME segment 2, and details are not repeatedly described in this embodiment.

Because IMAP4 allows a client device to acquire all or a portion of an email message, when the client device wants to acquire only a mail main body or an attachment, an email server returns only the MIME segment 1 body, the MIME segment 2 body, or the MIME segment 3 body shown in FIG. 2, but does not return information in the MIME segment 1 header, the MIME segment 2 header, or the MIME segment 3 header. Therefore, a network device such as a firewall or a gateway cannot learn encoding information of the mail main body or the attachment. The network device cannot perform a decoding operation to learn the mail main body or the attachment that is in decoded form; and further, the network device cannot perform security processing, such as antivirus processing or mail filtering, on content of the mail message that is in decoded form.

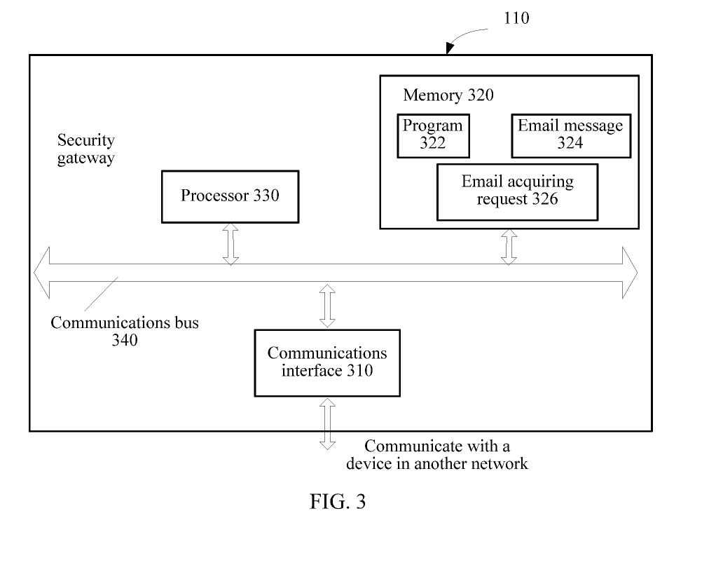

FIG. 3 is a schematic diagram of a physical structure of the security gateway 110 in FIG. 1 according to an embodiment of the present disclosure. As shown in FIG. 3, the security gateway 110 includes a communications interface 310, a memory 320, a processor 330, and a communications bus 340. The communications interface 310, the memory 320, and the processor 330 communicate with each other using the communications bus 340.

The communications interface 310 is configured to communicate with another device. The other device may include a device such as a client device, a switch, a router, or an email server.

The memory 320 is configured to store a program 322, cache an email acquiring request 326 sent by the client device 100, and cache an email message 324 sent by the email server 120. The memory 320 may include a high-speed random access memory (RAM), and may further include a non-volatile memory, for example, at least one magnetic disk memory. It can be understood that the memory 320 may be any non-transitory machine-readable medium that can store program code, such as a read-only memory (ROM), a RAM, a magnetic disk, a hard disk, an optical disc, or a non-volatile memory. The memory 320 may further cache another email operation request such as a request for reading an email message.

The program 322 may include program code, where the program code includes a computer operation instruction.

The processor 330 may be a central processing unit (CPU) or an application-specific integrated circuit (ASIC), or may be configured as one or more integrated circuits implementing the embodiments of the present disclosure.

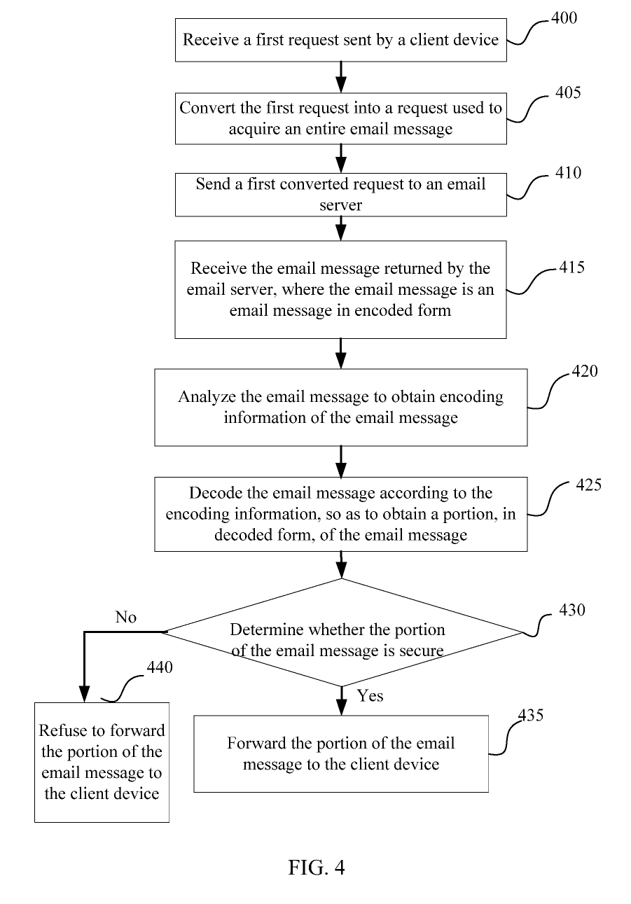

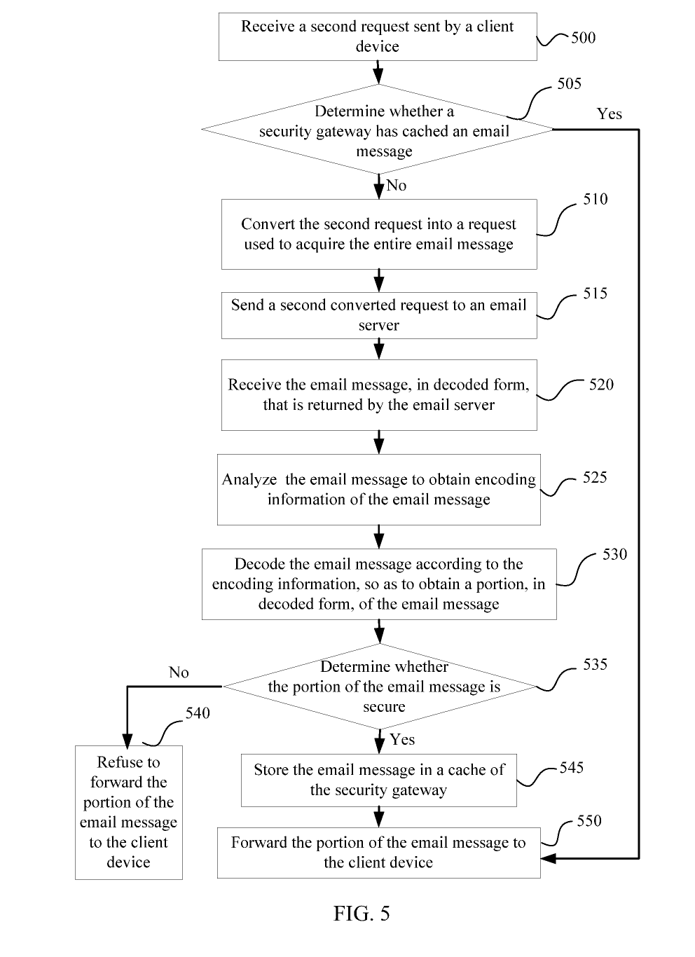

In this embodiment of the present disclosure, the processor 330 is configured to execute the program 322, and may execute related steps in method embodiments shown in FIG. 4 and FIG. 5.

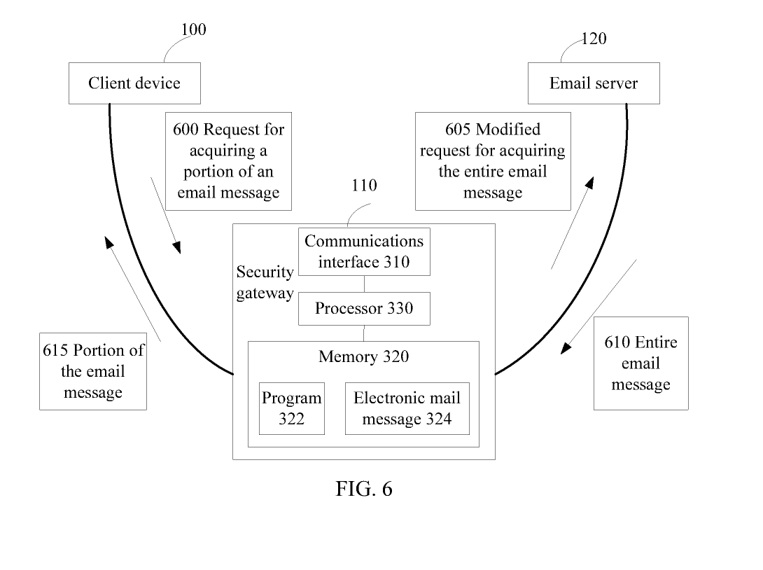

FIG. 4 is a flowchart of a method for processing an email request according to an embodiment of the present disclosure. The method may be executed by the security gateway 110 in FIG. 1 and FIG. 3. The security gateway 110 is configured to process a mail acquiring request sent by a client device, where the mail acquiring request is used to acquire a mail from an email server. The following describes the method in FIG. 4 with reference to FIG. 1 and FIG. 6. The method may include the following steps.

In step 400, the security gateway 110 receives a first request sent by the client device 100, where the first request is used to acquire a portion of an email message, and the portion of the email message does not include an email header of the email message.

In an actual application, a user may decide, by browsing the email header of the email message, to receive or browse only other portions, except the email header, of the email message. For example, a main body or an attachment of the email message may be received, or a main body and an attachment of the email message may be received. As shown in FIG. 6, FIG. 6 is a schematic signaling diagram of another method for processing an email request according to an embodiment of the present disclosure. In the schematic signaling diagram shown in FIG. 6, the client device 100 sends the first request 600 used to acquire the portion of the email message to the security gateway 110. The first request 600 sent by the client device 100 carries an email identifier (ID) of the email message and an ID of the to-be-acquired portion of the email message.

The first request 600 may be formatted according to IMAP4. More specifically, the first request 600 may be formatted based on a FETCH command of IMAP4. For example, the first request may be fhn6 UID FETCH 77 (BODY.PEEK[2]), and the first request is used to acquire a first attachment of an email message whose email ID is 77, where: “fhn6” is a tag of the request and is used to identify the request; “UID” is the email ID of the email message and can uniquely identify the email message; a UID may be a specific value, or may be a list or a range, where when a value of the UID is a list or a range, it is used to indicate multiple email messages; “FETCH” is a command that is specified by IMAP4 and that is used to acquire the email message; “77” is a value of the email ID UID; “2” is an ID of a to-be-acquired portion of the email message, and represents the first attachment of the email message; and “(BODY.PEEK[2])” indicates that it is requested to acquire the first attachment of the email message. It can be understood that the ID of the to-be-acquired portion of the email message may also be a specific value, a list, or a range. When the ID of the acquired portion of the email message is a list or a range, it is used to indicate that multiple portions of the email message are acquired. For example, “(BODY.PEEK[2-4])” is used to indicate that it is requested to acquire the first to third attachments of the email message.

A person skilled in the art can learn that, when the security gateway 110 performs proxy in a transparent proxy manner, the security gateway 110 may intercept an email message acquiring request sent by the client device 100 to the email server 120. When the security gateway 110 performs proxy in a non-transparent proxy manner, the client device 100 may directly send an email message acquiring request to the security gateway 110. This embodiment of the present disclosure sets no limit on a proxy manner of the security gateway 110.

In step 405, the security gateway 110 converts the first request 600 into a request 605 used to acquire the entire email message. After receiving the first request 600 of the client device 100, the security gateway 110 may construct, according to a command format specified by an IMAP4 protocol and according to the first request 600, the request 605 used to acquire the entire email message. For example, the request 605, fhn6 UID FETCH 77 (BODY.PEEK[]), used to acquire the entire email message may be formatted according to the first request 600: fhn6 UID FETCH 77 (BODY.PEEK[2]). Herein, the request 605 used to acquire the entire email message may be referred to as a first converted request 605.

In this step, the security gateway 110 may cache the first request 600 sent by the client device 100, and construct, according to the ID that is of the email message and that is in the first request 600, the request 605 used to acquire the entire email message.

In step 410, the security gateway 110 sends the first converted request 605 to the email server 120. For example, the security gateway 110 may send the first converted request 605, fhn6 UID FETCH 77 (BODY.PEEK[]), to the email server 120, to request the email server 120 to return, according to the first converted request 605, the entire email message.

In step 415, the security gateway 110 receives the email message 610 returned by the email server 120, where the email message 610 is an email message in encoded form. After receiving the first converted request, the email server 120 returns, according to the first converted request, the email message 610 indicated by a UID. The email message 610 returned by the email server 120 is an email message complying with a format specified by the MIME protocol. The email message in an MIME format includes mail content that is in encoded form. The mail content in encoded form refers to encoded mail content that is generated after the mail content is encoded using content transfer encoding information. For a structure of the email message 610 returned by the email server 120, refer to FIG. 2 and the related descriptions.

An MIME information header of the email message 610 returned by the email server 120 may include content of an email header and MIME header fields such as an MIME version and a content type. For example, an MIME information header of the email message whose UID is 77 and that is returned according to the first converted request 605 by the email server 120 is:

Date: Sun, 17 Feb 2013 11:10:02+0800 mail sent date

From: “123” _{123@123.com} sender information

To: “456” _{456@123.com} receiver information

Subject: test email subject

Mime-Version: 1.0 MIME version

Content-Type: multipart/mixed; content type

Boundary=“=====001_Dragon664320174586_=====” delimiter, which indicates a beginning and an end of an MIME segment.

An MIME segment 1 of the email message whose UID is 77 and that is returned by the email server 120 includes a main body that is of the email message and that is in encoded form, where an MIME segment 1 header includes encoding information of the main body of the email message, and an MIME segment 1 body includes content of the main body of the encoded email message. For example, the MIME segment 1 of the email message whose UID is 77 is:

--=====001_Dragon664320174586_===== indicates a beginning of the MIME segment 1;

Content-Type: text/plain;

char set=“gb2312” indicates that a content type of the MIME segment 1 is a type of text/plain, and a character set of text in the MIME segment 1 is “gb2312”;

Content-Transfer-Encoding: base64 indicates a transfer encoding type of the MIME segment 1 is base64; and

vPu4vbz+DQo=indicates an encoded main body of the email message.

An MIME segment 2 of the email message whose UID is 77 and that is returned by the email server 120 includes a first attachment that is of the email message and that is in encoded form, where an MIME segment 2 header includes encoding information of the first attachment of the email message, and an MIME segment 2 body includes encoded content of the first attachment. An MIME segment 3 includes a second attachment that is of the email message and that is in encoded form, where an MIME segment 3 header includes encoding information of the second attachment of the email message, and an MIME segment 3 body includes encoded content of the second attachment. For example, the MIME segment 2 of the email message whose UID is 77 is:

--=====001_Dragon664320174586_===== indicates a beginning of the MIME segment 2;

Content-Type: application/octet-stream;

name=”file1.txt” indicates that a content type of the MIME segment 2 is any binary data, and a name is “file1.txt”;

Content-Transfer-Encoding: base64 indicates that a transfer encoding type of the MIME segment 2 is base64;

Content-Disposition: attachment;

filename=”file1.txt” indicates that content of the MIME segment 2 is an attachment, and an attachment name is “file1.txt”; and

xPq6w6Ohuty439DLvPu1vcT6o6E=indicates encoded content of the first attachment.

In step 420, the security gateway 110 analyzes the email message 610 to obtain encoding information of the email message 610, where the encoding information includes Content-Transfer-Encoding information. As shown in FIG. 2, because the email message 610 returned by the email server 120 is in the format specified by MIME, the security gateway 110 may obtain the Content-Transfer-Encoding information of the email message 610 by analyzing the MIME information header or an MIME segment header of the email message 610, and may decode a corresponding portion of the email message 610 using the Content-Transfer-Encoding information of the email message 610. For example, the security gateway 110 may obtain Content-Transfer-Encoding: base64 from the MIME segment 2 header of the email message 610 whose UID is 77, so as to learn that transfer encoding information of the first attachment of the email message is base64.

It should be noted that, if the Content-Transfer-Encoding information is included in the MIME information header, the Content-Transfer-Encoding information may be used to decode the entire email message. If the Content-Transfer-Encoding information is included in an MIME segment header, the Content-Transfer-Encoding information can act on only the MIME segment, and be used to decode an MIME segment body of the MIME segment.

In addition, the security gateway 110 may further obtain character set (char set) information that is in the email message 610 by analyzing the email message 610. More specifically, the security gateway 110 may obtain, from the email message 610 returned by the email server 120, Content-Type information of each MIME segment of the email message 610, such that the security gateway 110 may determine a packet type of the MIME segment according to the obtained Content-Type information. For example, the packet type may be text, image, audio, or the like. In addition, the Content-Type information may further include a character set (char set) of a text encoding manner of the MIME segment. For example, in the email message whose UID is 77 described above, in the MIME segment 1, char set=“gb2312” indicates that a character set of text in the MIME segment 1 is “gb2312”. Neither the MIME information header nor the MIME segment 2 includes char set information, and therefore, a character set type in the MIME segment 2 is a default character set type: ASCII.

In step 425, the security gateway 110 decodes the email message 610 according to the encoding information, so as to obtain the portion, in decoded form, of the email message. More specifically, that which encoding manner is used may be learned provided that the encoding information is obtained, and then a decoding manner corresponding to the encoding manner is used to perform decoding to obtain mail content that is of the portion, in decoded form, of the email message.

For example, the security gateway 110 may decode encoded attachment content “xPq6w6Ohuty439DLvPu1vcT6o6E=” that is in the MIME segment 2 according to the transfer encoding manner base64, to obtain content, in decoded form, of the first attachment in the email message whose UID is 77: “Hello! Nice to meet you!”

It can be understood that the security gateway 110 may decode the entire email message 610, or may decode only the portion, required by the client device 100, of the email message, which is not limited in this embodiment. For example, the security gateway 110 may decode the entire email message 610 according to the Content-Transfer-Encoding information in the MIME information header, or may decode content of a body of an MIME segment in the MIME segment according to Content-Transfer-Encoding information in a header of the MIME segment. If the header of the MIME segment does not include Content-Transfer-Encoding information, the security gateway 110 may decode content of the body of the MIME segment according to the Content-Transfer-Encoding information in the MIME information header.

In step 430, the security gateway 110 performs security processing on the portion, in decoded form, of the email message, so as to determine whether the portion of the email message is secure. In an actual application, after the security gateway 110 decodes the email message, the security gateway 110 may further perform, according to a set security policy, the security processing on the portion, in decoded form, of the email message. If it is determined, after the security processing is performed, that the email message 610 is a secure email message, go to step 435; otherwise, go to step 440.

The set security policy may include a virus detection and removal policy, a filtering policy, and the like. For example, a security operation such as virus detection and removal may be performed on the decoded email message according to the preset virus detection and removal policy, or content filtering may be performed on the decoded email message according to the character set (char set) information in the email message and the preset filtering policy, so as to prevent the client device 100 from receiving an email message with a virus, a junk mail, or an email message with a sensitive field, thereby protecting security of the client device.

In one situation, when it is required to filter an email message received by the client device 100, a filtering policy may be generated in advance according to a string that needs to be filtered and a preset character set. In an email filtering process, it is first determined whether char set information in the portion of the email message is consistent with char set information in the filtering policy. If the char set information in the portion of the email message is consistent with the char set information in the filtering policy, decoded mail content of the portion of the email message is directly matched with the string that needs to be filtered and that is in the filtering policy. If the char set information in the portion of the email message is inconsistent with the char set information in the filtering policy, decoded mail content of the portion of the email message needs to be converted according to the char set information in the filtering policy, and then is matched with the string that needs to be filtered and that is in the filtering policy, so as to determine whether the portion of the email message includes the string that needs to be filtered.

For example, the security gateway 110 may filter, according to the set filtering policy, content, in decoded form, of the first attachment of the email message whose UID is 77. The filtering policy set in the security gateway 110 may be: filtering an email message with a string of “advertisement”, and character set information that is set for filtering a string is “gb2312”. It can be understood that, the security gateway 110 may generate, by compiling, a status machine according to the string that needs to be filtered and that is configured in the filtering policy and according to the char set information. Because char set information of the first attachment of the email message whose UID is 77 is ASCII, and the char set information in the generated status machine is “gb2312”, the char set information of the first attachment is inconsistent with the char set information in the status machine. Therefore, when the first attachment of the email message is filtered according to the set filtering policy, the content of the first attachment needs to be converted into content that is in a format of “gb2312”; and then the converted content is matched using the status machine, to determine whether the first attachment includes the to-be-filtered string “advertisement”. If the first attachment does not include the to-be-filtered string “advertisement”, it is considered that the email message 610 is secure; otherwise, it is considered that the email message 610 is an insecure email message.

It should be noted that, after the security gateway 110 obtains the mail content of the portion of the email message, security processing, such as antivirus processing or mail filtering, performed on the mail content of the portion of the email message is only several processing manners enumerated in this embodiment of the present disclosure. In an actual application, other processing may further be performed on the mail content, which is not limited in this embodiment.

In step 435, the security gateway 110 forwards the portion 615 of the email message to the client device 100. After determining that the portion 615 of the email message is secure, the security gateway 110 may forward the portion 615 of the email message to the client device 100. For example, if the security gateway 110 determines, after performing security processing on the email message 610, that the email message 610 is a secure email message, or the security gateway 110 determines, after performing processing such as virus detection and removal on the email message 610, that the processed email message 610 is a secure email message, the security gateway 110 may forward the portion 615 of the email message to the client device 100 according to the ID that is of the portion of the email message and that is carried in the first request 600, so as to end the process of the method. For example, the security gateway 110 may return the first attachment in the email message whose UID is 77 to the client device 100 according to an attachment ID “2” in the first request fhn7 UID FETCH 77 (BODY.PEEK[2]).

In step 440, the security gateway 110 refuses to forward the portion of the email message to the client device. If the security gateway 110 determines, after performing security processing on the email message 610, that the email message 610 is an insecure email, the security gateway 110 may refuse to forward the portion 615 of the email message to the client device 100. For example, the security gateway 110 may send, to the client device 100, information that acquiring of the email message fails, discard the email message 610, or send a modified email message 610 to the client device 100. For example, the security gateway 110 may screen out or modify some sentences in the email message 610 and then send the email message 610 to the client device 100, so as to perform security protection on the client device 100.

According to the method for processing an email request shown in FIG. 4, a security gateway 110 converts a request 600 that is used to acquire other portions, except an email header, of an email message and that is of a client device 100 into a request 605 for acquiring the entire email message, such that the security gateway 110 can acquire, from the entire email message 610 returned by an email server 120, content transfer encoding information of the portion 615, to be acquired by the client device 100, of the email message. In addition, the security gateway 110 may use the content transfer encoding information of the portion of the email message to decode the portion 615 of the email message, such that the security gateway 110 can also obtain content of the portion, in decoded form, of the email message in an application scenario in which the client device 100 acquires only the portion, except the email header, of the email message, thereby enhancing protection of the client device 100.

In another situation, to improve a speed of the client device 100 in acquiring an email message, the security gateway 110 may further cache an email message obtained from the email server 120. More specifically, the security gateway 110 may further process, using a method shown in FIG. 5, a mail acquiring request sent by the client device 100, where the mail acquiring request is used to acquire, from the email server 120, a portion of the email message. FIG. 5 is a flowchart of another method for processing an email request according to an embodiment of the present disclosure. The method may also be executed by the security gateway 110 in FIG. 1, FIG. 3, and FIG. 6. The following describes the method shown in FIG. 5 with reference to FIG. 1 and FIG. 6. As shown in FIG. 5, the method may include the following steps.

In step 500, the security gateway 110 receives a second request sent by the client device 100, where the second request is used to acquire a portion of an email message, and the portion of the email message does not include an email header of the email message.

The second request is also formatted based on a FETCH command of IMAP4. For example, the second request may be fhn7 UID FETCH 77 (BODY.PEEK[3]), and is used to request the email server to return a second attachment of an email message whose email ID is 77, where “77” is the email ID of the email message, and “3” is an ID of a to-be-acquired portion of the email message. For detailed descriptions about the request sent by the client device, refer to the related descriptions in the embodiment in FIG. 4.

It should be noted that the first and the second in the first request, the second request, the first converted request, and the second converted request in the embodiments of the present disclosure are only for clarity of description and for distinguishing the requests sent by the client device rather than for setting any limit on a time, a sequence, or the like of the requests sent by the client device.

In step 505, the security gateway 110 determines whether the security gateway 110 has cached the email message. Because in a network system shown in FIG. 1, the security gateway 110 generally processes, in a proxy manner, a mail operation request sent by the client device 100. The security gateway 110 has a caching function. For example, the security gateway 110 may continuously cache an email message acquired from the email server 120 in a local cache. After receiving the second request of the client device 100, the security gateway 110 determines, according to the second request, whether the security gateway 110 has stored the email message required to be acquired by the client device 100. If the security gateway 110 does not store the email message required to be acquired by the client device 100, the security gateway 110 may execute step 510. If the security gateway 110 has stored the email message required to be acquired by the client device 100, the security gateway 110 may directly execute step 550, and directly send the portion of the email message, stored by the security gateway 110, to the client device 100. In this way, a speed and efficiency of the client device 100 in acquiring the email message can be significantly improved.

More specifically, when determining whether the email message is cached, the security gateway 110 may determine, according to an email ID carried in the second request, whether the email message is cached.

In step 510, the security gateway 110 converts the second request into a request used to acquire the entire email message. The security gateway 110 may construct, according to the email ID carried in the second request and a command format specified by IMAP4, the request 605 used to acquire the entire email message. For example, the request, fhn7 UID FETCH 77 (BODY.PEEK[]), used to acquire the entire email message may be formatted according to the second request: fhn7 UID FETCH 77 (BODY.PEEK[3]); herein the request used to acquire the entire email message may be referred to as a second converted request.

It can be understood that, in this step, the security gateway 110 may first cache the second request sent by the client device 100 in the memory 320, and then construct, according to the email ID in the second request, the request 605 used to acquire the entire email message.

In step 515, the security gateway 110 sends the second converted request to the email server. For example, the security gateway 110 may send the second converted request fhn7 UID FETCH 77 (BODY.PEEK[]) to the email server 120, to request the email server 120 to return, according to the second converted request, the entire email message whose UID is 77.

In step 520, the security gateway 110 receives the email message 610, in encoded form, that is returned by the email server 120. The email message 610 returned by the email server 120 has a format specified by MIME, and for details, refer to the related descriptions in the embodiments shown in FIG. 2 and FIG. 4.

In step 525, the security gateway 110 analyzes the email message 610 to obtain encoding information of the email message.

In step 530, the security gateway 110 decodes the email message 610 according to the encoding information, so as to obtain the portion, in decoded form, of the email message.

In step 535, the security gateway 110 performs security processing on the portion, in decoded form, of the email message, so as to determine whether the portion of the email message is secure. If the security gateway 110 determines, after performing the security processing, that the email message is a secure email message, go to step 545; otherwise, go to step 540.

In step 540, the security gateway 110 refuses to forward the portion of the email message to the client device.

In step 545, the security gateway 110 stores the email message in the cache of the security gateway 110. More specifically, when it is determined, in step 505 according to the email ID carried in the second request, that the security gateway 110 has not cached the email message 610, it means that the security gateway 110 has not obtained the email message 610 from the email server 120. When performing security processing on the decoded email message 610 and determining that the email message 610 is secure, the security gateway 110 may store the email message 610 in the cache of the security gateway 110. When the security gateway 110 receives again a request for acquiring the email message 610, the security gateway 110 may directly forward the email message 610 or any portion of the email message 610 in the cache to the client device 100, so as to improve a speed and efficiency of the client device 100 in obtaining the email message.

In step 550, the security gateway 110 forwards the portion 615 of the email message to the client device. In one situation, if the security gateway 110 determines, after performing security processing on the email message 610, that the email message 610 is a secure email message, or the security gateway 110 determines, after performing processing such as virus detection and removal on the email message 610, that the processed email message is a secure email message, the security gateway 110 may forward the portion 615 of the email message to the client device 100 according to the ID that is of the portion of the email message and that is carried in the second request. For example, the security gateway 110 may return the second attachment in the email message whose UID is 77 to the client device 100 according to an attachment ID “3” in the second request fhn7 UID FETCH 77 (BODY.PEEK[3]).

In another situation, when the security gateway 110 determines, in step 505, that the security gateway 110 has cached the email message 610, the security gateway 110 may also directly execute step 550, and forward the portion 615 of the email message, cached in the security gateway 110, to the client device 100 according to the ID that is of the portion 615 of the email message and that is carried in the second request, so as to improve a speed and efficiency of the client device 100 in obtaining the email message.

It should be noted that the step of caching the email message 610 (for example, step 545 in FIG. 5) may be executed after the email message 610 is obtained from the email server 120, or may be executed after security processing is performed on the email message 610, or may be executed before the portion 615 of the email message is forwarded to the client device 100, or may be executed at the same time the portion 615 of the email message is forwarded to the client device 100, which is not limited in this embodiment. It can be understood that, if the email message 610 is cached after the email message 610 is obtained and before security processing is performed on the email message 610, when it is found, after the security processing is performed on the email message 610, that the email message is insecure, the email message 610 may be deleted from the cache.

It can be clearly understood by a person skilled in the art that, for ease and brevity of description, for descriptions of some steps in the embodiment shown in FIG. 5, refer to the detailed descriptions in the corresponding process in the embodiment shown in FIG. 4.

According to the method for processing an email request shown in FIG. 5, a security gateway 110 can first determine, after receiving a request that is for acquiring a portion of an email message and that is sent by a client device 100, whether the email message required to be acquired by the client device 100 is stored in a cache. If the security gateway 110 has stored the email message required to be acquired by the client device 100, the security gateway 110 may directly send the portion of the email message, stored by the security gateway 110, to the client device 100, such that a speed and efficiency of the client device 100 in acquiring the email message can be significantly improved. If the security gateway 110 does not store the email message required to be acquired by the client device 100, the security gateway 110 converts the request of the client device 100 into a request for acquiring the entire email message, such that the security gateway 110 can acquire, from the entire email message returned according to the converted request by the email server 120, content transfer encoding information of the portion, to be acquired by the client device 100, of the email message. Further, the security gateway 110 may decode the portion of the email message using the content transfer encoding information of the portion of the email message, such that the security gateway 110 can also identify and obtain content of the portion, acquired by the client device 100, of the email message. Further, the security gateway 110 may perform a security processing operation such as mail filtering or virus detection and removal on content of the decoded portion of the email message, and then forward the portion of the email message to the client device 100, so as to ensure security of the client device 100. More further, the security gateway 110 can further cache, after determining that the email message is secure, the email message acquired from the email server 120, such that the security gateway 110 can return the cached email message to the client device 100 after receiving a mail operation request of the client device 100 subsequently, so as to improve a speed and efficiency of the client device 100 in acquiring the email message.

It should be noted that, the embodiments provided by the application are only exemplary, and the security gateway in the embodiments of the present disclosure is also only an example of the network device. The embodiments of the present disclosure may also be applied to another network device, for example, a firewall, provided that the network device can implement, based on IMAP4, a mail proxy function, which is not limited herein. In addition, the network device in the embodiments of the present disclosure may be separately deployed on a network as an independent device, or may be located in another device such as a firewall or a gateway, which is not limited herein either.

What is claimed is:

1. A network device, comprising:
a communications interface configured to communicate with a client device and an email server; and
a processor configured to:
receive a first request from the client device for fetching a portion of an email message, wherein the portion of the email message does not comprise a header of the email message;
generate a second request for fetching the email message in its entirety according to the first request;
send the second request to the email server;
receive the email message in an encoded form from the email server;
decode the email message to obtain the portion in a decoded form; and
forward the portion of the email message to the client device.

2. The network device according to claim 1, wherein the first request from the client device and the second request are formatted according to Internet Message Access Protocol 4 (IMAP4).

3. The network device according to claim 1, wherein the first request comprises an email identifier (ID) and an ID of the portion, and wherein the processor is configured to:
generate, according to the email ID, the second request for fetching the email message in its entirety; and
forward the portion of the email message to the client device according to the ID of the portion of the email message.

4. The network device according to claim 1, wherein the processor is further configured to perform a security operation on the portion in the decoded form to determine that the portion is safe.

5. The network device according to claim 4, wherein the security operation is performed according to a security policy and character set information obtained from the email message.

6. The network device according to claim 1, wherein the processor is further configured to store the email message in a cache of the network device.

7. The network device according to claim 6, wherein the processor is further configured to:
receive a third request from the client device for fetching a second portion of the email message, wherein the second portion of the email message does not comprise a header of the email message, and wherein the third request comprises an email ID and an ID of the second portion of the email message;
determine, according to the email ID, that the email message is cached in the network device; and
forward the second portion of the email message to the client device according to the ID of the second portion.

8. A method performed by a network device for processing requests from a client device to retrieve emails from an email server, comprising:
receiving a first request from the client device for fetching a portion of an email message, wherein the portion of the email message does not comprise a header of the email message;
generating a second request for fetching the email message in its entirety according to the first request;
sending the second request to the email server;
receiving the email message in an encoded form from the email server;
decoding the email message to obtain the portion in a decoded form; and
forwarding the portion of the email message to the client device.

9. The method according to claim 8, wherein the first request from the client device and the second request are formatted according to Internet Message Access Protocol 4 (IMAP4).

10. The method according to claim 8, wherein the first request comprises an email identifier (ID) of the email message and an ID of the portion of the email message, wherein generating the second request for fetching the email message in its entirety according to the first request comprises generating, according to the email ID, the second request for fetching the email message in its entirety, and wherein forwarding the portion of the email message to the client device comprises forwarding the portion of the email message to the client device according to the ID of the portion of the email message.

11. The method according to claim 8, further comprising performing a security operation on the portion in the decoded form to determine that the portion of the email message is safe.

12. The method according to claim 11, further comprising obtaining character set information from the email message returned by the email server, wherein performing the security operation on the portion in the decoded form to determine that the portion is safe comprises performing, according to a security policy and the character set information, the security operation on the portion in the decoded form to determine that the portion of the email message is safe.

13. The method according to claim 8, further comprising storing the email message in a cache of the network device.

14. The method according to claim 13, further comprising:
receiving a third request from the client device for fetching a second portion of the email message, wherein the second portion of the email message does not comprise the header of the email message, and wherein the third request contains an email ID of the email message and an ID of the second portion of the email message;
determining, according to the email ID, that the email message is cached in the network device; and
forwarding the second portion of the email message to the client device according to the ID of the second portion of the email message.

15. A non-transitory machine-readable medium that provides instructions, which when executed by a processor in a network apparatus, cause the network apparatus to perform operations comprising:
receiving a first request from the client device for fetching a portion of an email message, wherein the portion of the email message excludes a header of the email;
generating a second request for fetching the email message in its entirety according to the first request;
sending the second request to the email server;
receiving the email message in an encoded form from the email server;
decoding the email message to obtain the portion in a decoded form; and
forwarding the portion to the client device.

16. The non-transitory machine-readable medium according to claim 15, wherein the first request from the client device and the second request are formatted according to the Internet Message Access Protocol 4 (IMAP4).

17. The non-transitory machine-readable medium according to claim 15, wherein the first request contains an email identifier (ID) and an ID of the portion, and wherein the non-transitory machine-readable medium further provides instructions that, when executed by the processor in the network apparatus, cause the network apparatus to perform operations comprising:
generating the second request for fetching the email message in its entirety according to the email ID; and
forwarding the portion to the client device according to the ID of the portion.

18. The non-transitory machine-readable medium according to claim 15, wherein the non-transitory machine-readable medium further provides instructions that, when executed by the processor in the network apparatus, cause the network apparatus to perform operations comprising performing a security operation on the portion in the decoded form to determine that the portion is safe.

19. The non-transitory machine-readable medium according to claim 18, wherein the non-transitory machine-readable medium further provides instructions that, when executed by the processor in the network apparatus, cause the network apparatus to perform operations comprising obtaining character set information from the email message received from the email server, and wherein performing the security operation on the portion in the decoded form to determine that the portion is safe comprises performing the security operation on the portion in the decoded form to determine that the portion is safe according to the character set information and a security policy.

20. The non-transitory machine-readable medium according to claim 15, wherein the non-transitory machine-readable medium further provides instructions that, when executed by the processor in the network apparatus, cause the network apparatus to perform operations comprising:
storing the email message in a cache of the network apparatus;
receiving a third request from the client device for fetching a second portion of the email message, wherein the second portion of the email message excludes a header of the email message, and wherein the third request contains an email ID and an ID of the second portion;
determining, according to the email ID, that the email message is cached in the network apparatus; and
forwarding, according to the ID of the second portion, the second portion of the email message to the client device.
